(19) United States
(12) Patent Application Publication
(10) Pub. No.: US 2006/0266743 A1
(43) Pub. Date: Nov. 30, 2006

(54) Laser-ablated fiber devices and method of manufacturing the same

(75) Inventors: Sien Chi, Hsinchu (TW); Nan-Kuang Chen, Hsinchu (TW)

Correspondence Address: Haverstock And Owens LLP, 162 North Wolfe Road, Sunnyvale, CA, 94086, US

(73) Assignee: National Chiao Tung University

(21) Appl. No.: 11/439,673

(22) Filed: May 23, 2006

(30) Foreign Application Priority Data
May 30, 2005 (TW) 094117738

(51) Int. Cl. B23K 26/00

(52) U.S. Cl. 219/121.69; 219/121.68

(57) ABSTRACT

A manufacturing method of a laser-ablated fiber device is proposed. The fiber cladding is removed by laser beam until the evanescent field is accessed. The depth of ablation is controlled by measuring the distance between the interference fringes of the laser. The effective interaction length is tuned by varying the radius of curvature of the fiber. The ablated fibers are mated to act as a fiber coupler. Subsequently, the interaction region is fused or fused-tapered to make a fiber coupler, an add/drop multiplexer, a fiber filter, etc.

### FIELD OF THE INVENTION

The present invention relates to a method for manufacturing laser-ablated fiber devices. More particularly, the present invention relates to a method of manufacturing laser-ablated fiber devices through the laser ablation.

### BACKGROUND OF THE INVENTION

The side-polished fiber coupler was first proposed by Lab. of Prof. Shaw, Stanford University. Referring to FIG. 1(a), the fiber 11 is buried in the quartz base plate 12, and the cladding of the fiber is polished so that there is a distance of several micro meters between the polished cladding and the core, and then the side-polished fiber device is mutually stacked to form the fiber coupler 13, as shown in FIG. 1(b). The fiber coupler has advantages of a low loss (<0.5 dB) and a tunable coupling ratio. However, this kind of fiber coupler has low stability with respect to the environment and thus has no commercial value as a result of shortcomings like insufficiency in polished length, necessity of a refractive index matched liquid, and a high production cost therefore. Nowadays, only a few companies manufacture this kind of fiber coupler, which are mainly applied in the tunable fiber coupler in the field of the polarization maintaining fiber.

Kawasaki first proposed a method for manufacturing a fused-tapering fiber coupler with moving flame, and the method is now a leading technology in manufacturing fiber couplers because of its easiness and speed. Such a method is easy and it is used to manufacture different kinds of fiber devices, such as a fiber polarizer, a polarization filter splitter, and a wavelength multiplexer/demultiplexer. However, such a method has a fatal shortcoming, i.e. it fails to manufacture fiber devices at a high quality. That is, lights of different states of polarization will have different coupling coefficients when a dumb-bell cross section is formed by two fibers fused-tapered. As long as the length of fused-tapering becomes longer, the phase difference between two polarization states will enormously increase due to birefringence of the coupling region, and thus the channel isolation of the fiber device becomes bad. However, the channel wavelength separation depends on the interaction length of the fiber coupler. Accordingly, it is not easy to manufacture a fiber coupler with a narrow channel spacing and high channel isolation. Besides, this method is not suitable for manufacturing low loss and polarization isotropic coarse-wavelength-division-multiplexing (CWDM) fiber couplers.

C. V. et al. fused the side-polished fiber devices to increase the stability of the side-polished fiber coupler as a result of advantages and drawbacks from side-polishing and fused-tapering. However, the technology they develop in polishing fibers utilizes a grinder, and it is necessary to add a thin film of sol-gel silica to fill in between the polished surfaces of the fibers when the fibers are fused. Although the abovementioned method improves the stability of the side-polished fiber coupler, due to the deficient manufacture process and a tapering process not considered, the coupling ratio and wavelength coupling characteristics are not tunable. Accordingly, this method is not practical.

It is disclosed in the Taiwan Patent No. 4930690 (Tzeng et al.) that two side-polished fibers are combined by fusion, wherein a fine-tuned stretch is applied to adjust the phase relation between the two eigen-modes of the fiber coupler so as to obtain a desired coupling ratio. The stretch applied to the fiber is used to fine-tune the phase difference between the two eigen-modes of fiber coupler so that the desired wavelength is coupled to desired output port of fiber coupler. Accordingly, the core of the fiber is not deformed in the stretch process, that is, the structure of the first and second cores still exist in the fiber coupler and the signals mainly propagate in core. However, the side-polished fiber devices lack the practical value in commercial use because the process of manufacturing side-polished fiber devices is time-consuming and they consume a large amount of polishing slurry and pads and precision silicon V-grooves.

The U.S. Pat. No. 5,101,090 (Methods and apparatus for making optical fiber couplers) proposed a method of excimer laser ablation to remove local cladding into a notch. The stop point for the ablation while approaching the vicinity of the core depends on a signal laser light obliquely shooting into fiber core through the notch, and a photodetector at the output of the fiber simultaneously measures the output power of the signal laser light. When the measured power exceeds a threshold to reach a desired ablation depth, the excimer laser is signaled to stop. The structure is also applied in the method for manufacturing a fiber coupler. However, it is obvious that a notch formed by the laser ablation to the fiber will lead to an abrupt change in the mode field distribution as a result of an abrupt change in thickness of the cladding and produce a phenomenon of coupling of high order mode, thereby resulting in severe optical losses of guiding lights. Moreover, the ablation depth is judged by the power variations of the signal laser, and it is difficult to know the accurate remained cladding thickness since coupling efficiency of signal laser is so poor due to the mismatch between propagation constants of signal laser light and guiding lights in the ablated fiber. Thus, this method cannot reflect an accurate ablation depth. It is also mentioned in this patent that the cladding ablated by the excimer laser is a polymer material, which is different from the standard fused silica fiber cladding. The excimer laser may not be used to ablate the photosensitive Ge-doped fiber so as not to induce index variation of the core.

From the above description, it is known that how to develop a method of manufacturing laser-ablated fiber devices through the laser ablation has become a major problem to be solved. In order to overcome the drawbacks in the prior art, an improved method of manufacturing laser-ablated fiber devices through the laser ablation is proposed. The particular design in the present invention not only solves the problems described above, but also is easy to be implemented. Thus, the invention has the utility for the industry.

### SUMMARY OF THE INVENTION

The main purpose of the present invention is to propose a manufacturing method of laser-ablated fiber devices. The cladding of the fiber is directly ablated by the laser so that an evanescent field of the fiber is exposed, wherein the ablation depth is estimated according to the distance between the interference fringes from another laser light. During the laser ablation, the fiber has to be kept bent so that the ablation depth of the cladding, where a depth is formed, gradually changes and thus a loss of the light is avoided. A length formed by ablating the fiber is controlled by varying the radius of curvature of the fiber. Besides, when the laser beam ablates a straight fiber, the traveling trajectory of the laser beam could be programmed so that any shape of the ablation on the cladding after can be designed and thus a loss of the light is avoided. This kind of laser-ablated fiber devices can be utilized to manufacture an evanescent wave fiber coupler, a fiber add/drop multiplexer, a fiber filter, a fiber polarizer, a fiber amplifier, and such active/passive fiber components as the fiber laser and fiber gratings.

### BRIEF DESCRIPTION OF THE DRAWINGS

FIGS. 1(a)˜1(b) are schematic diagrams showing the method for manufacturing the side-polished fiber coupler in the prior art;

FIG. 2 is a schematic diagram showing the structure of the fiber coupler according to a preferred embodiment of the present invention;

FIGS. 3(a)˜3(b) are schematic diagrams showing the structure of the fiber coupler according to another preferred embodiment of the present invention (by multiple fibers);

FIG. 3(c) is a structural diagram of the fiber coupler based on laser ablation of the present invention;

FIGS. 4(a)˜4(b) are schematic diagrams showing another method for manufacturing the laser-ablated fiber device of the present invention;

FIG. 5(a) is a photograph of the cross section of the ablated fiber;

FIG. 5(b) is a photograph of interference fringes from the center region of laser ablated fiber;

FIG. 5(c) is a photograph of interference fringes from the edge region of laser-ablated fiber;

FIGS. 6(a)˜6(b) are schematic diagrams showing the application of the method for manufacturing the laser-ablated fiber of the present invention;

FIG. 7 is a schematic diagram showing the 2×2 and 4×4 fiber couplers manufactured by the laser ablation method of the present invention;

FIG. 8 is a schematic diagram showing the N×N fiber couplers manufactured by the laser ablation method of the present invention;

FIG. 9(a) is a schematic diagram showing the fiber add-drop multiplexer manufactured by the laser ablation method of the present invention;

FIG. 9(b) is a schematic diagram showing the fiber add-drop multiplexer in series manufactured by the laser ablation method of the present invention;

FIG. 10 is a schematic diagram showing the wavelength tunable narrowband fiber multiplexer/demultiplexer manufactured by the laser ablation method of the present invention;

FIGS. 11(a)˜11(b) are schematic diagrams showing the fiber grating manufactured by the laser ablation method of the present invention; and

FIG. 12 is a schematic diagram showing another tunable fiber add-drop multiplexer in series manufactured by the laser ablation method of the present invention.

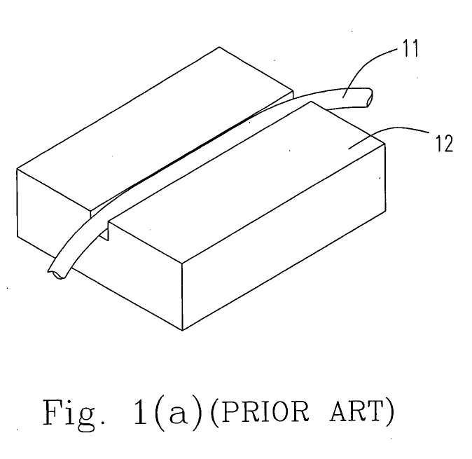

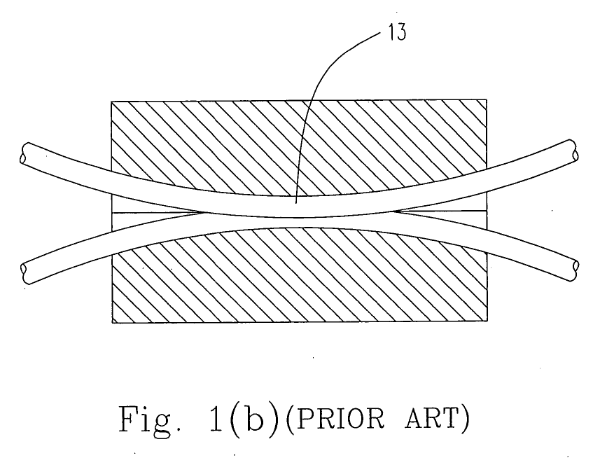

### DETAILED DESCRIPTION OF THE PREFERRED EMBODIMENT

The present invention proposes a method for manufacturing laser-ablated fiber devices for different applications and will now be described more specifically with reference to the following embodiments. It is to be noted that the following descriptions of preferred embodiments of this invention are presented herein for purposes of illustration and description only; it is not intended to be exhaustive or to be limited to the precise form disclosed.

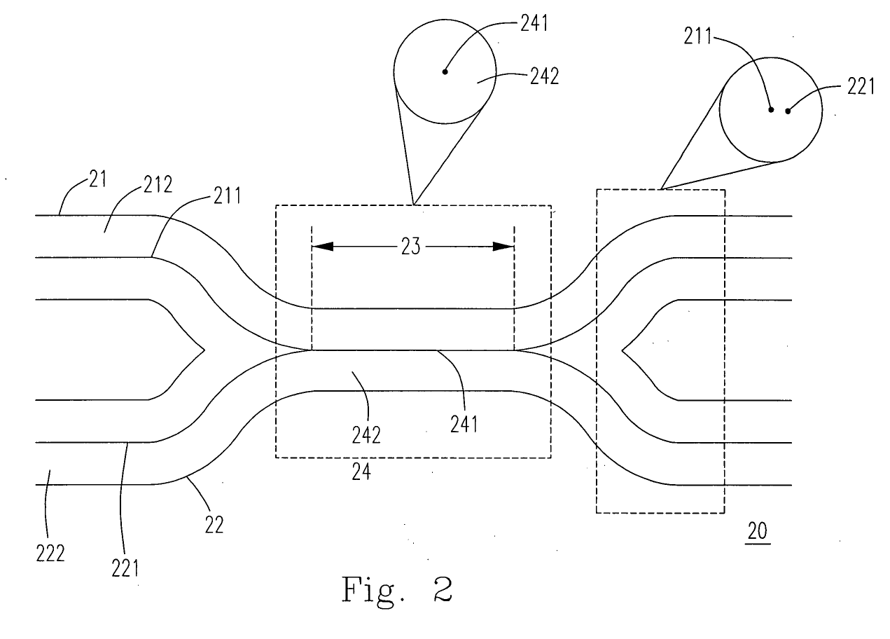

Please refer to FIG. 2, which is a schematic diagram showing the structure of the fiber coupler according to a preferred embodiment of the present invention. The method for manufacturing the fiber coupler 20 in FIG. 2 includes the following steps. Firstly, the fiber 21 and 22 are prepared, wherein the fiber 21 comprises the core 211 and the cladding 212, and the fiber 22 comprises the core 221 and the cladding 222. Next, a laser beam is utilized to respectively ablate the claddings 212 and 222 to form two evanescent field surfaces (not shown) so that the respective evanescent field surfaces of the fibers 21 and 22 are exposed outside the claddings 212 and 222. After annealing, the two evanescent field surfaces are mated to form a combination region 23. Then, the combination region 23 is fused so that the coupling of the fibers 21 and 22 occurs. During the coupling process, a stepping motor is utilized to stretch the fibers 21 and 22 with gradual tension force to adjust the length of the coupling region 24 and the proportion of the coupling of the light phase. In the meantime, the cores 211 and 221 taper and couple to form a core 241, which loses its guiding effect. Namely, it is part of the cladding 242, located in the coupling region, of the claddings 212 and 222 that replace the cores 211 and 221 to carry out the guiding effect. The action of adjusting the length of the coupling region 24 stopped after the desired coupling ratio is obtained. Finally, a package layer (not shown) is utilized to package the coupling region 24 to form the fiber coupler 20, wherein the materials for manufacturing the packaging layer can be metal, ceramics, glass, polymer, or materials having temperature compensating effects.

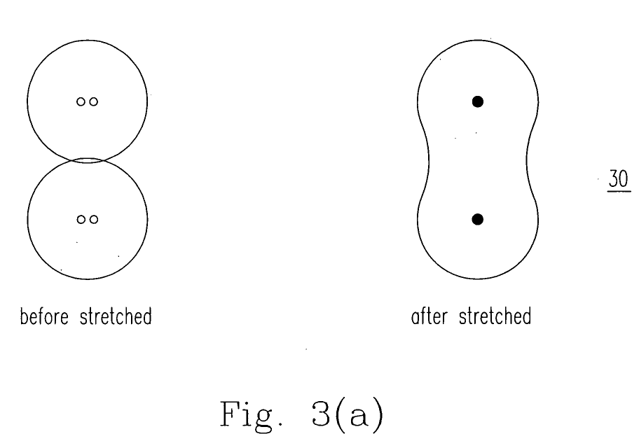

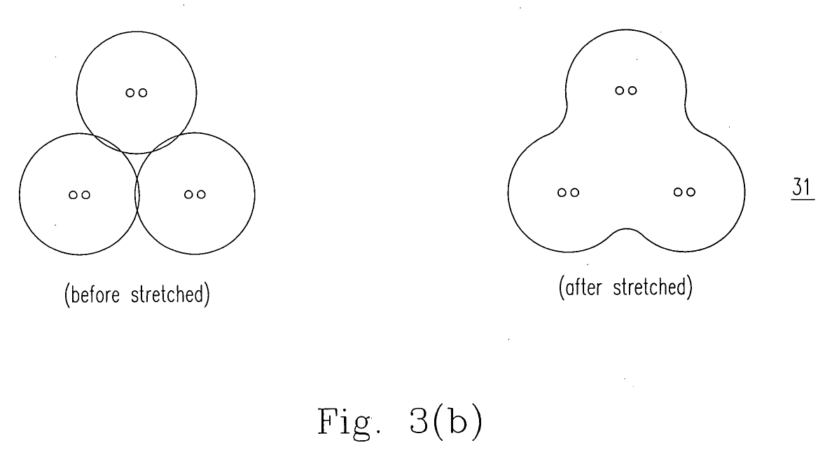

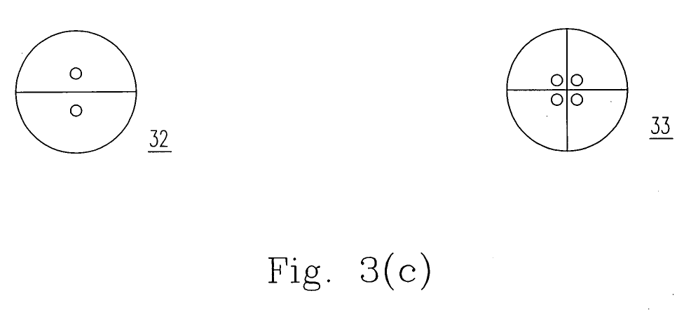

Certainly, the method of the present invention is not confined to the case of two fibers. Besides the 4×4 fiber coupler 30 illustrated in FIG. 3(a), the 6×6 fiber coupler 31 of three fibers or more can be applied to the manufacturing process. It should be noted that the fiber couplers 32 and 33 as illustrated in FIG. 3(c) can be formed by ablating more than two fibers in a more regular way according to the abovementioned method of laser ablation. Compared to the abovementioned fiber coupler 31, the difference in functionality is that the fiber grating can be further inscribed in fiber couplers 32 or 33 since the photosensitive Ge-doped cores are not deformed. Namely, this method can manufacture a fiber coupler or an add/drop multiplexer with a fiber grating. The present invention aims to solve the severe polarization of the anisotropy in the present fused-tapered fiber couplers and the poor performance of the channel isolation when it is applied to the narrow channel spacing multiplexer/demultiplexer. Firstly, the present commercial products can only achieve a channel spacing of around 70 nm, wherein the channel isolation is decreased to a level of 12-15 dB. On the contrary, the channel isolation of the coupler of the present invention can achieve a level of 30 dB. Secondly, the poor performance of the channel isolation in the prior art results from the cause that a highly asymmetric dumb-bell of the cross section of the coupler leads to different coupling coefficients of lights of different polarization states. Under such a circumstance of the application in the narrow channel spacing multiplexer/demultiplexer, a long interaction length must be required, which further gives rise to a more severe phase difference between the light of two polarization states so that the channel isolation deteriorates. However, the structure and manufacturing method of the coupler in the present invention overcome the abovementioned drawback.

Besides, the present invention also solves such problems as bad stability and insufficient effective reaction length of the conventional side-polished fiber coupler. Although C. V. Cryan et al. proposed a concept of fusing the side-polished fibers as a fiber coupler, their method for polishing the fiber by a grinder leads to a limitation in the effective interaction length and a necessity of using a thin film of sol-gel silica during fusion to compensate for the difficulty in aligning the two fibers. Besides, they did not mention that a fused-polished fiber coupler was stretched to considerably increase the effective interaction length either so that the guiding effect couples the cladding to manufacture a narrow channel spacing fiber coupler. On the contrary, because the fiber coupler of the present invention is almost symmetrically circular, the cross section of the fiber will still be symmetrically circular after fusion without producing a conventional dumb-bell structure and polarization anisotropy. Accordingly, the fiber can be stretched to a long elongation length while the channel isolation will not be deteriorated, and the circular fiber cross section will still remain circular after elongation to any extent by fused-tapering. Accordingly, such a method is able to manufacture a fiber coupler with a narrow channel spacing and low crosstalk that is very suitable for application in the optical communication of high density, which is unachievable by the present related method for manufacturing the fiber coupler.

Besides, if the cross section of the laser-ablated fiber is covered with a material, e.g. an optical gain media, a non-linear optical material, an optical dispersive material, an optical birefringence material, or a liquid crystal, or photonic crystal is employed to surround the cross section of the laser-ablated fiber before a package thereof is carried out, it will be utilized to manufacture other different kinds of fiber devices.

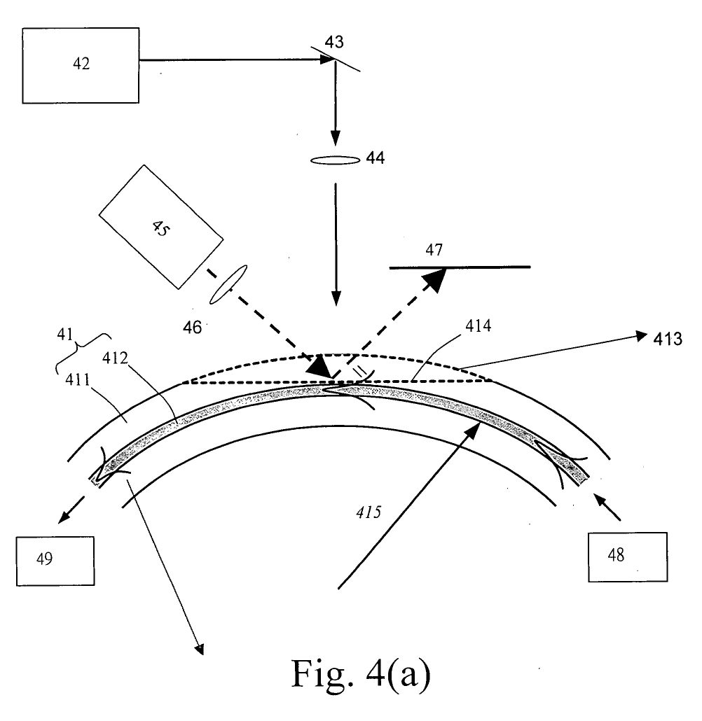

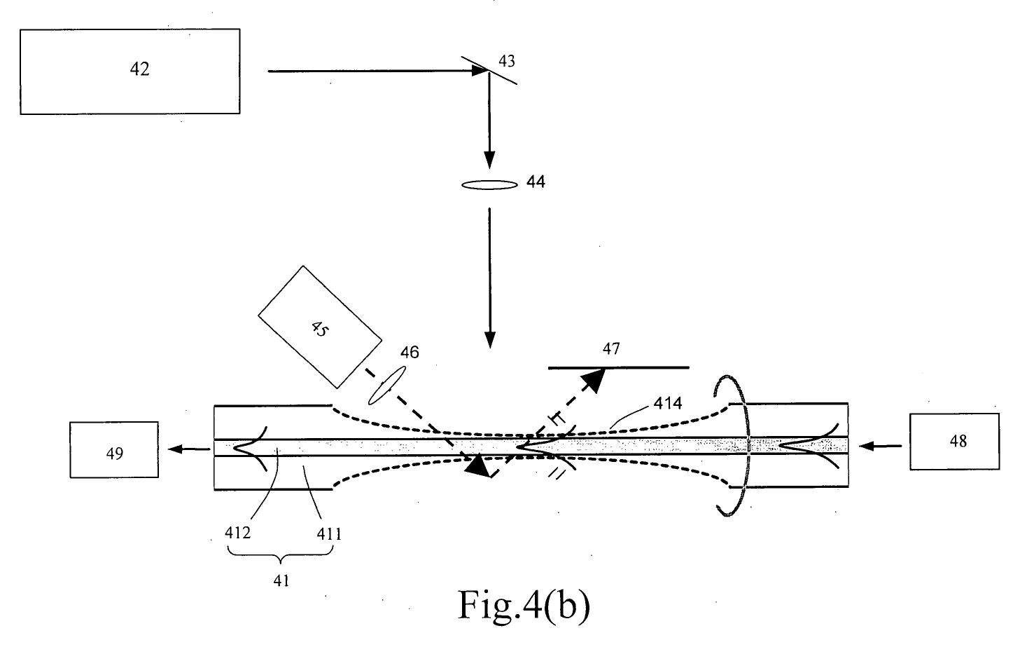

Please refer to FIG. 4(a), which is a schematic diagram showing another method for manufacturing the laser-ablated fiber device of the present invention. As shown in FIG. 4(a), the laser-ablated fiber device includes a cladding 411, a fiber 41 of a core 412, a first laser 42, a reflection mirror 43, a focus lens 44, a second laser 45, a focus lens 46, a screen 47, a third laser 48, and a light detector 49.

In FIG. 4(a), a first laser 42 is employed to ablate the portion 413 from the cladding 411. In the ablation process, the ablation range 413 encompasses the whole evanescent field surface 414 resulting from the moving of the reflection mirror 43 and the focus lens. Subsequently, the second laser light 45 injects into the evanescent filed surface 414. The depth of the ablated cladding 411 by the first laser 42 can be determined according to the distance between the interference fringes showing on the screen 47. The interference comes from the optical path differences between different locations of the ablation region. Besides, if the fiber 41 to be ablated is bent as a state of the radius of curvature 415 before the ablation is carried out, the interaction length of the cladding 41 by the first laser 42 is determined by controlling the curvature 415.

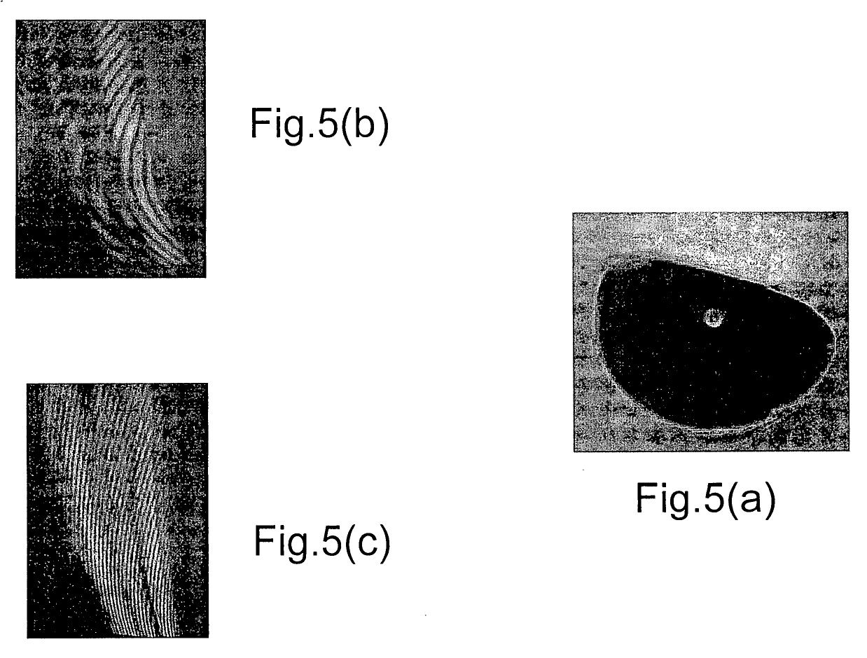

Please refer to FIG. 4(b), which is a schematic diagram showing another method for manufacturing the laser-ablated fiber device of the present invention. The elements shown in FIG. 4(b) have the same reference numerals as those shown in FIG. 4(a). As compared with FIG. 4(a), the only difference is that the fiber 41 is rotated when the fiber 41 is ablated by the first laser 42 so that the evanescent field surface 414 in an encircling state is presented on the fiber 41. FIG. 5(a) is a photograph of the cross section of the ablated fiber, FIG. 5(b) is a photograph of the interference fringes from the center region of the ablation region of fiber, and FIG. 5(c) is a photograph of the interference fringes from edge region of the ablation region of fiber. The difference between FIG. 5(b) and 5(c) shows that ablation depth can be accurately obtained from interference fringes.

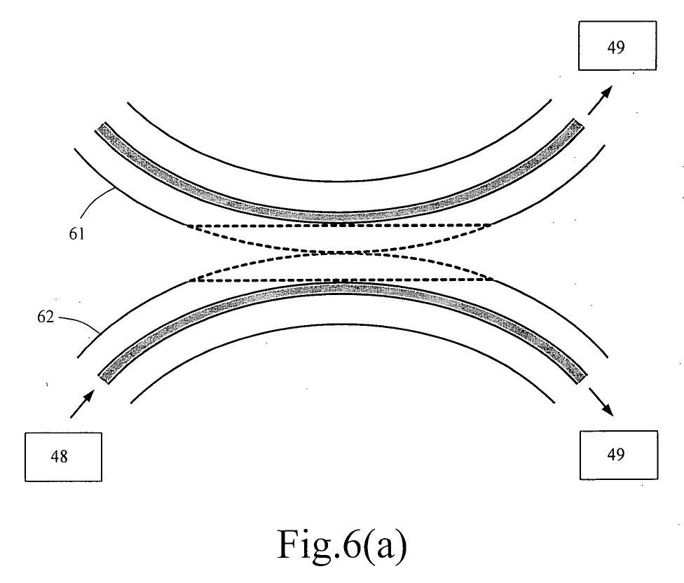

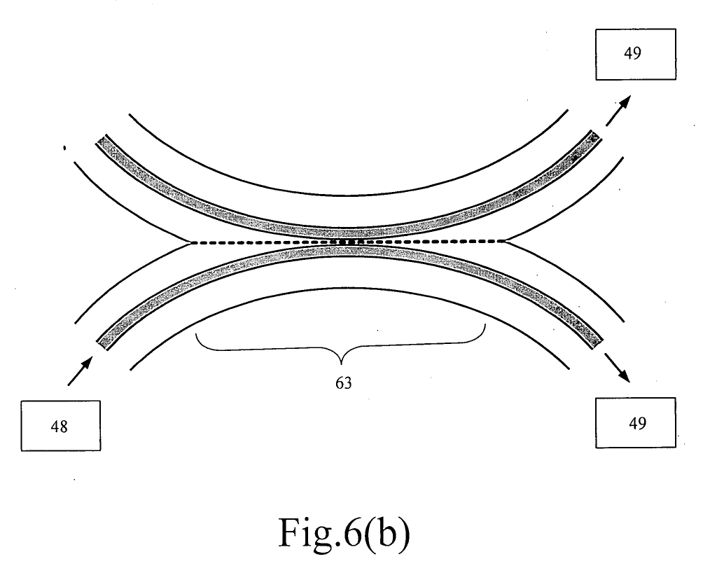

Please refer to FIGS. 6(a) and 6(b), which are schematic diagrams showing the application of the method for manufacturing the laser-ablated fiber of the present invention. After two ablated fibers 61 and 62 are manufactured according to the abovementioned ablation method and the ablated portions thereof are combined with each other, heated, and fused, a coupling region 63 is formed. Besides, a proportion of the light coupling could be changed if a slight stretch is applied to the coupling region 63. Certainly and alternatively, the stretch does not have to be applied to the coupling region 63.

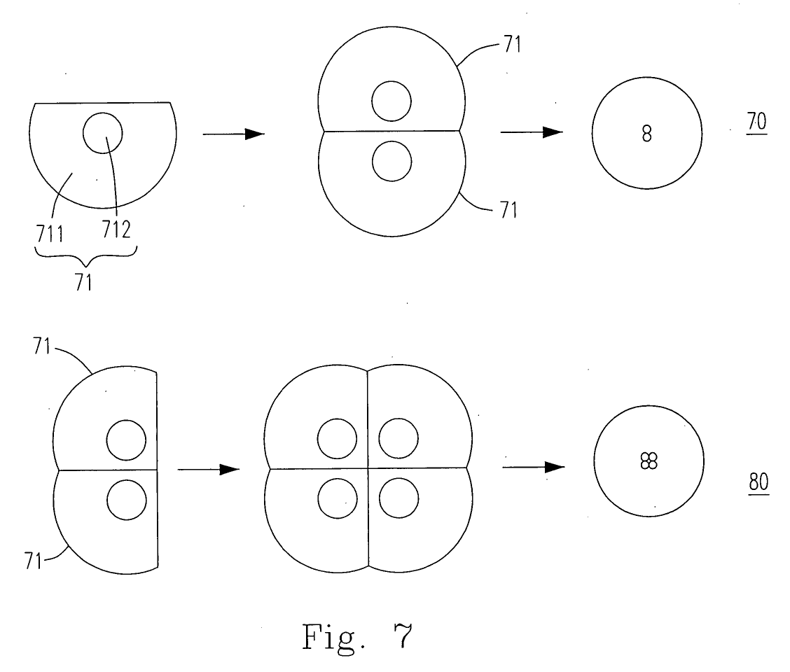

Please refer to FIG. 7, which illustrates the 2×2 and 4×4 fiber couplers manufactured by the laser ablation method of the present invention. To manufacture the 2×2 fiber coupler, a fiber device 71 is manufactured by the abovementioned laser ablation method, and then the ablated portions of the two identical structures of the fibers 71 are fused and stretched after combination so as to null the original core 712 and form the 2×2 fiber coupler 70. To manufacture the 4×4 fiber coupler, the combination of the two fiber devices 71 is completed according to the method for manufacturing the 2×2 fiber coupler, where the laser ablation is carried out, and then the two identical structures are fused and stretched after combined with each other to form the 4×4 fiber coupler 80.

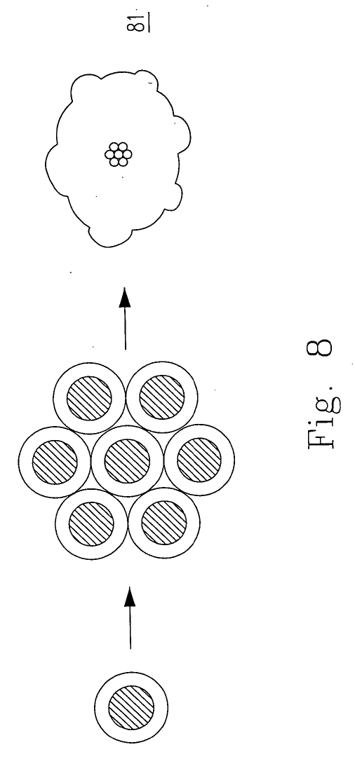

Please refer to FIG. 8, which illustrates the N×N fiber coupler by the laser ablation method of the present invention (7×7 for example). To manufacture the N×N fiber coupler, a fiber device 71 is manufactured by the abovementioned method of encircling laser ablation, and the N fiber devices are combined with each other by the ablated portions thereof to be fused and stretched so that an N×N fiber coupler 81 is formed.

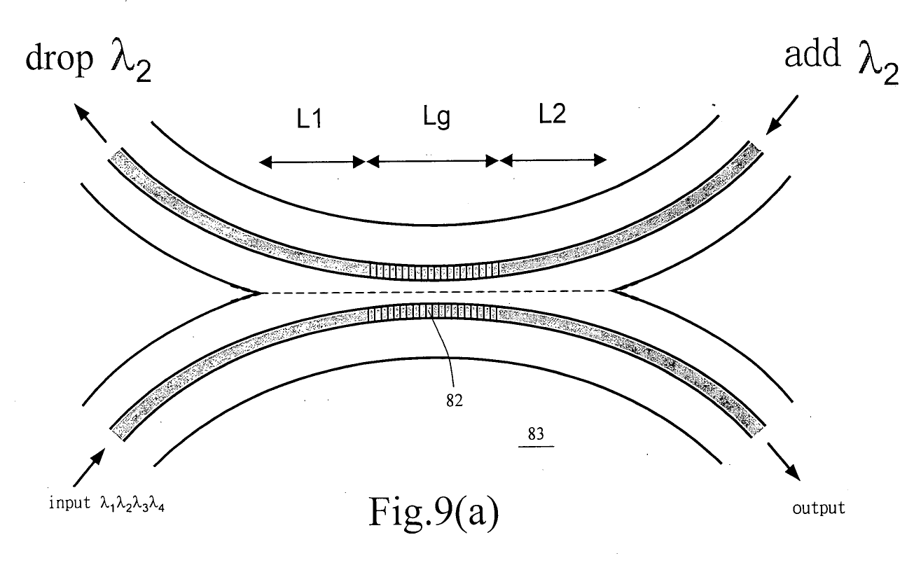

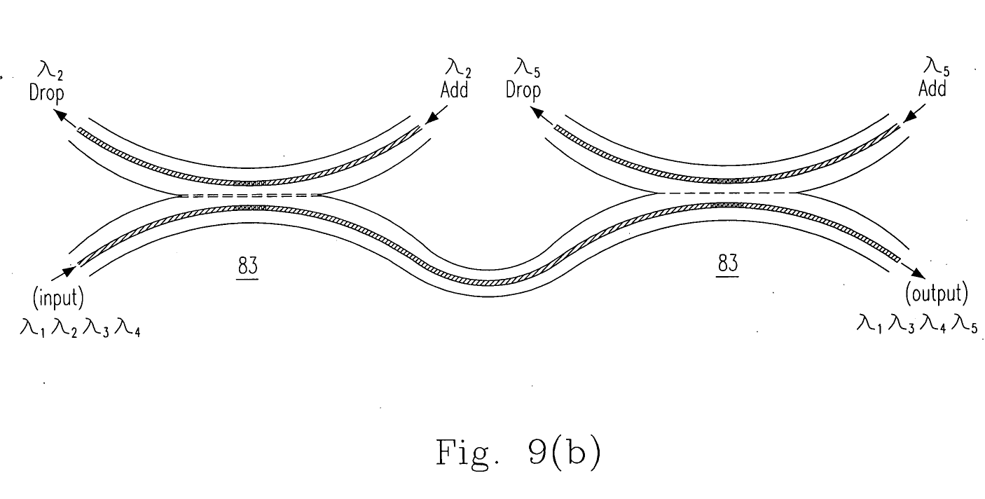

Please refer to FIG. 9(a), which illustrates a fiber add-drop multiplexer by the laser ablation method of the present invention. Similarly, two fiber devices 71 are manufactured by the abovementioned method of laser ablation, and then the two fiber devices 71 are combined together by the respective ablated portions and fused and stretched, wherein the fiber grating 82 is written into the coupling region to form an add/drop multiplexer 83. Please refer to FIG. 9(b), which illustrates a fiber add/drop multiplexer in series by the laser ablation method of the present invention. It is formed by a connection of the output and input terminals of the two abovementioned add/drop multiplexers 83.

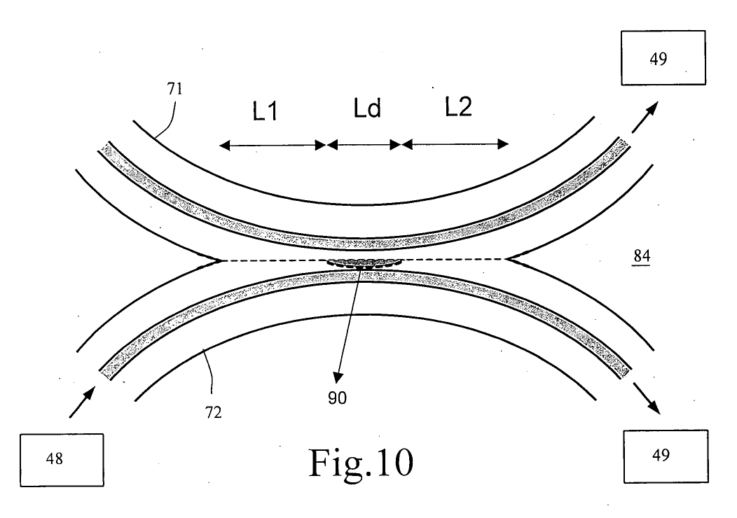

Please refer to FIG. 10, which illustrates a wavelength tunable narrowband fiber multiplexer/demultiplexer by the laser ablation method of the present invention. In spite of the abovementioned method of laser ablation for manufacturing the two fiber devices 71 and 72, there is a difference that the depth to ablate the fiber device 72 is made deeper so that a difference between the depths there forms a gap. A dispersive material with a refractive index capable of tuning by temperature is filled into the gap after fusion, and thus a wavelength tunable narrowband fiber multiplexer/demultiplexer 84 is formed.

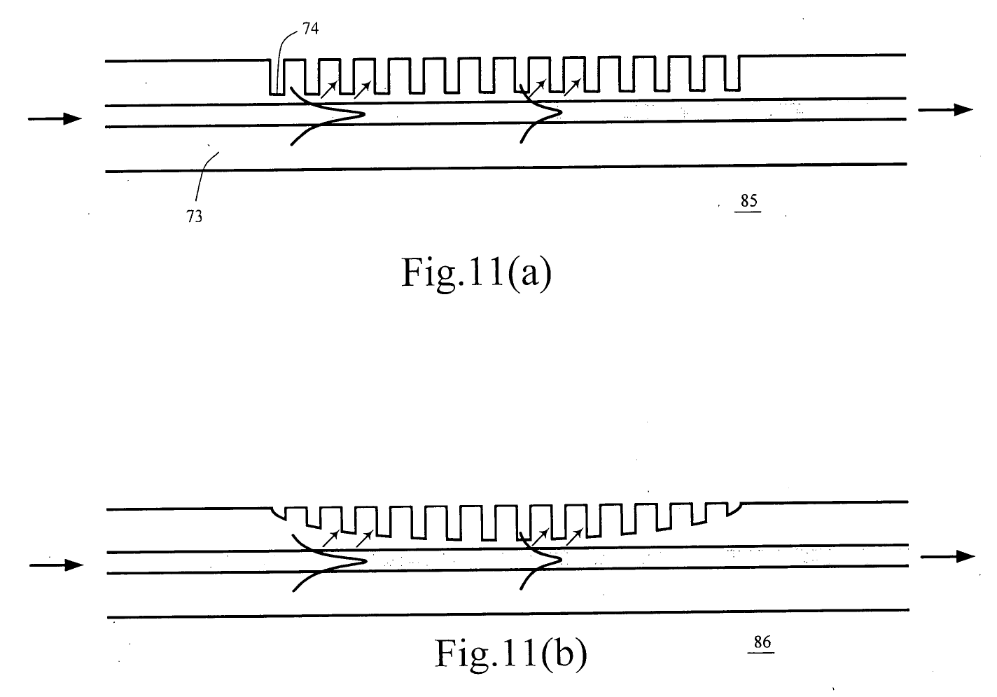

Please refer to FIG. 11 (a), which illustrates the fiber grating by the laser ablation method of the present invention. In this method, a first laser ablates the fiber 73 at intervals to form plural evanescent field surfaces 74 thereon so that the fiber grating is formed. Besides, if the ablation depth by the first laser is slowly modulated, the fiber grating 86 with an evanescent field surface 74 apodized is probably formed, as shown in FIG. 11(b).

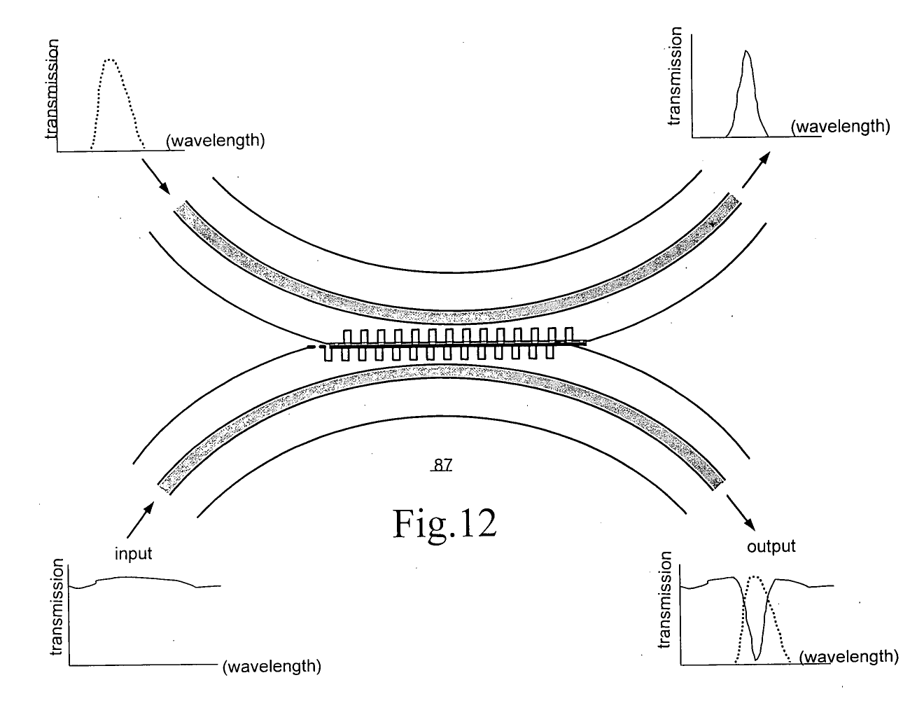

Please refer to FIG. 12, which illustrates another tunable fiber add/drop multiplexer by the laser ablation method of the present invention. In this method, two fiber gratings 85 as shown in FIG. 11(a) are bonded with each other and fused, wherein dispersive materials whose indices are tunable by temperature are filled in into the portion of plural gaps to form the tunable fiber add/drop multiplexer 87.

To summarize, the present invention proposes a method for manufacturing a laser-ablated fiber, wherein a portion of the cladding of the fiber is directly ablated by the laser so that the evanescent field surface in the fiber is exposed, an ablation depth is determined by measuring the distance of the interference fringes of the laser light, and the interaction length of the evanescent field surface formed by the laser ablation could be controlled by changing the radius of curvature of the fiber. Laser-ablated fibers are then mated with each other so that the evanescent filed surfaces thereof couple and one of fusion and fuse-tapering is applied to manufacture fiber devices, e.g. a fiber coupler, an add/drop multiplexer, a narrowband fiber multiplexer/demultiplexer, and a fiber grating.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for manufacturing a laser-ablated fiber device, comprising steps of:
(a) providing a fiber having a core and a cladding;
(b) ablating the cladding to form an evanescent field surface by a first laser beam; and
(c) projecting a second laser beam into the evanescent field surface to form a reflected beam;
wherein a depth to ablate the cladding by using the first laser beam is determined according to a parameter formed by the reflected beam.

2. The method as claimed in claim 1, wherein the parameter is based on a distance between interference fringes formed by the reflected beam.

3. The method as claimed in claim 1, wherein the step (b) further comprises a step of rotating the fiber when the cladding is ablated by the first laser beam, and thereby the evanescent field surface encompasses the fiber.

4. The method as claimed in claim 1, wherein the step (b) further comprises a step of bending the fiber while ablating the cladding by the first laser beam, and a length to ablate the cladding by the first laser beam is determined according to a radius of curvature formed when the fiber is bended.

5. The method as claimed in claim 1, wherein the step (b) further comprises a step of reflecting the first laser beam by at least a reflection mirror before the first laser beam ablates the cladding.

6. The method as claimed in claim 5, wherein the step (b) further comprises a step of modulating the at least a reflection mirror, and thereby the first laser beam forms an ablation range to achieve the evanescent surface.

7. The method as claimed in claim 6, wherein the step of modulating is one of moving and rotating.

8. The method as claimed in claim 1, wherein the step (b) further comprises a step of focusing the first laser beam by at least a lens before the first laser beam ablates the cladding.

9. A method for manufacturing a fiber coupler, comprising steps of:
(a) providing a first fiber having a first core and a first cladding and a second fiber having a second core and a second cladding;
(b) ablating the first cladding of the first fiber by a first laser beam to form a first evanescent field surface, and projecting a second laser beam into the first evanescent field surface to form a first reflected beam, wherein a depth to ablate the first cladding by using the first laser beam is determined according to a parameter formed by the first reflected beam;
(c) repeating the step (b) for the second fiber to form a second evanescent field surface; and
(d) mating the first and second evanescent field surfaces to form the fiber coupler.

10. The method as claimed in claim 9, wherein the parameter in the step (b) is based on a distance between interference fringes formed by the first reflected beam.

11. The method as claimed in claim 9, wherein the step (d) is performed by fusion and stretching.

12. The method as claimed in claim 9, wherein the step (b) further comprises a step of rotating the first fiber when the first cladding is ablated by the first laser beam, and thereby the first evanescent field surface encompasses the first fiber.

13. The method as claimed in claim 9, wherein the step (b) further comprises a step of bending the first fiber while ablating the first cladding by the first laser beam, and a first length to ablate the first cladding by the first laser beam is determined according to a first radius of curvature formed when the first fiber is bended.

14. The method as claimed in claim 9, wherein the step (b) further comprises a step of reflecting the first laser beam by at least a first reflection mirror before the first laser beam ablates the first cladding.

15. The method as claimed in claim 14, wherein the step (b) further comprises a step of modulating the at least a reflection mirror, and thereby the first laser beam has a first ablation range including the first evanescent field surface.

16. The method as claimed in claim 15, wherein the step of modulating is one of moving and rotating.

17. The method as claimed in claim 9, wherein the step (b) further comprises a step of focusing the first laser beam to ablate the first cladding by at least a lens before the first laser beam ablates the first cladding.

18. A method for manufacturing a fiber coupler, comprising steps of:
(a) providing plural fibers each having a core and a cladding;
(b) rotating a specific fiber when the cladding thereof is ablated by a first laser beam to form an evanescent field surface encompassing the specific fiber, and providing a second laser beam to the evanescent field surface to form a first reflected beam, wherein a depth to ablate the cladding using the first laser beam is determined according to a parameter formed by the first reflected beam;
(c) repeating the step (b) for all the other fibers; and
(d) mating all evanescent field surfaces of the plural fibers to form the fiber coupler.

19. The method as claimed in claim 18, wherein the parameter in the step (b) is based on a distance between interference fringes formed by the first reflected beam.

20. The method as claimed in claim 18, wherein the step (d) is performed by fusion and stretching.

21. A method for manufacturing an add-drop multiplexer, comprising steps of:
(a) providing a first fiber having a first core and a first cladding and a second fiber having a second core and a second cladding;
(b) ablating the first cladding of the first fiber by a first laser beam to form a first evanescent field surface, and projecting a second laser beam into the first evanescent field surface to form a first reflected beam, wherein a depth to ablate the first cladding by using the first laser beam is determined according to a parameter formed by the first reflected beam;
(c) repeating the step (b) for the second fiber to form a second evanescent field surface;
(d) dealing with the first and second evanescent field surfaces of the first and second fibers by a process;
(e) inscribing fiber gratings into the first and second cores; and
(f) stretching the first and second fibers to adjust optical characteristics, thereby forming the add-drop multiplexer.

22. The method as claimed in claim 21, wherein the parameter in the step (b) is based on a distance between interference fringes formed by the first reflected beam.

23. The method as claimed in claim 21, wherein the process comprises mating and fusion.

24. A method for manufacturing a multi-wavelength add-drop multiplexer by connecting a plurality of add-drop multiplexers as claimed in claim 21 in series.

25. A method for manufacturing a wavelength-tunable fiber multiplexing/demultiplexing device, comprising steps of:
(a) providing a first fiber having a first core and a first cladding and a second fiber having a second core and a second cladding;
(b) ablating the first cladding of the first fiber by a first laser beam to form a first evanescent field surface, and projecting a second laser beam into the first evanescent field surface to form a first reflected beam, wherein a depth to ablate the first cladding by using the first laser beam is determined according to a parameter formed by the first reflected beam;
(c) repeating the step (b) for the second fiber, and making a second depth to ablate the second cladding deeper than the first depth;
(d) dealing with the first and second evanescent field surfaces of the first and second fibers to form a gap by a difference between the first and second depths by a process;
(e) filling in a dispersive material into the gap, thereby forming the wavelength-tunable fiber multiplexing/demultiplexing device.

26. The method as claimed in claim 25, wherein the wavelength-tunable fiber multiplexing/demultiplexing device is one of a tunable fiber narrowband multiplexer, demultiplexer, and add/drop filter.

27. The method as claimed in claim 25, wherein the parameter in the step (b) is based on a distance between interference fringes formed by the first reflected beam.

28. The method as claimed in claim 25, wherein the process comprises mating and fusion.

29. The method as claimed in claim 25, wherein the dispersive material is a polymer composite.

30. The method as claimed in claim 25, wherein the dispersive material has a refractive index changing with a temperature.

31. A method for manufacturing a fiber grating, comprising steps of:
(a) providing a fiber having a core and a cladding; and
(b) ablating the cladding at intervals by a first laser beam to form a plurality of evanescent field surfaces and projecting a second laser beam into the plurality of evanescent surfaces to form a plurality of reflected beams, wherein a plurality of depths to ablate the cladding are determined according to a plurality of parameters formed by the plurality of reflected beams, and the fiber grating is formed thereby.

32. The method as claimed in claim 31, wherein the plurality of parameters in the step (b) are based on a plurality of distances among interference fringes formed by the plurality of reflected beams.

33. The method as claimed in claim 31, wherein the first laser beam is modulated so as to apodize the fiber grating.

34. A method for manufacturing a tunable fiber add-drop multiplexer, comprising steps of:
(a) providing two fibers both having a fiber grating as claimed in claim 31;
(b) dealing with the two fiber gratins by a process, wherein a plurality of evanescent field surfaces between the two fiber gratings form a plurality of gaps; and
(c) filling in a dispersive material into the plurality of the gaps to form the tunable fiber add-drop multiplexer.

35. The method as claimed in claim 33, wherein the process comprises mating and fusion.

36. The method as claimed in claim 33, wherein the dispersive material is a polymer composite.

37. The method as claimed in claim 33, wherein the dispersive material has a refractive index changing with a temperature.
